(19) United States
(12) Patent Application Publication
(10) Pub. No.: US 2025/0305857 A1
(43) Pub. Date: Oct. 2, 2025

(54) METHODS AND SYSTEMS FOR DISTRIBUTED FIBER OPTIC SENSING

(71) Applicant: FIBER SENSE LIMITED, Mosman, NSW (AU)

(72) Inventors: Mark Andrew ENGLUND, Mosman, New South Wales (AU); Nathaniel LINDSEY, Oakland, CA (US)

(21) Appl. No.: 18/864,885

(22) PCT Filed: May 9, 2023
(86) PCT No.: PCT/AU2023/050387

§ 371 Date: Nov. 11, 2024

(30) Foreign Application Priority Data
May 9, 2022 (AU) 2022901233

(51) Int. Cl. G01D 5/353; G01H 9/00; H04B 10/071

(52) U.S. Cl. CPC G01D 5/35358; G01H 9/004; H04B 10/071

(57) ABSTRACT

A distributed fibre optic sensing (DFOS) method is disclosed. The method includes (a) repeatedly transmitting interrogating optical signals into at least one optical fibre: (b) receiving backscattered optical signals in a distributed manner along the at least one optical fibre: (c) combining the backscattered optical signals and an optical reference signal: (d) processing the combined signals to determine at least one polarisation state change of the backscattered optical signals along the at least one optical fibre; and (e) determining at least one birefringence event based on the at least one polarisation state change

### TECHNICAL FIELD

The present disclosure generally relates to systems and methods for distributed sensing based on one or more optical fibres. More particularly, aspects of the present disclosure relate to distributed polarisation sensing (DPS) for detecting one or more birefringence events and isolating these events from the background, for example, including one or more acoustic and weight-induced strain events and/or other noise.

### BACKGROUND

Fibre optic sensing, more specifically distributed fibre optical sensing (DFOS), can detect acoustic emission and vibration from objects and events in surrounding regions along at least one optical fibre. DFOS may also detect and locate physical movements of the at least one optical fibre and/or in the environment surrounding the at least one optical fibre. In an example where the at least one optical fibre forms part of a fibre-optic communications network, physical handling/movement of the optical fibre, such as moving, pulling, bending and twisting of the optical fibre and/or physical movements in the environment surrounding the optical fibre may lead to network errors, network flap events and/or network outages.

Reference to any prior art in the specification is not, and should not be taken as, an acknowledgement or any form of suggestion that this prior art forms part of the common general knowledge in any jurisdiction or that this prior art could reasonably be expected to be understood, regarded as relevant and/or combined with other pieces of prior art by a person skilled in the art.

### SUMMARY OF THE DISCLOSURE

Distributed fibre optic sensing (DFOS) systems and components for DFOS and related DFOS methods are described. The DFOS systems and methods may be used to facilitate better discrimination of one or more birefringence events (e.g. associated with physical handling of an optical fibre, which may further lead to a network error or outage or flap event) from the background which may include acoustic disturbances, weight-induced strain activities and/or other detected noise.

A DFOS method is described, which includes: (a) repeatedly transmitting interrogating optical signals into at least one optical fibre; (b) receiving backscattered optical signals in a distributed manner along the at least one optical fibre; (c) combining the backscattered optical signals and an optical reference signal; (d) processing the combined signals to determine at least one polarisation state change of the backscattered optical signals along the at least one optical fibre; (e) determining at least one birefringence event based on the at least one polarisation state change.

In some embodiments, the DFOS method further includes distributed acoustic sensing (DAS) and processing the backscattered optical signals in parallel to determine at least one acoustic and/or weight-induced strain disturbance in addition to the at least one birefringence event. In some embodiments, determining at least one acoustic disturbance is based on a spatial differentiation of phase difference between the backscattered optical signals and the optical reference signal.

In some embodiments, determining the at least one birefringence event is based on the at least one polarisation state change exceeding a predetermined threshold.

In some embodiments, the at least one optical fibre forms at least part of a fibre-optic communications network; and step (e) in paragraph includes determining at least one network error or outage or flap event in physical layer according to the at least one birefringence event, including determining location of the at least one network error or outage or flap event. In some embodiments, the DFOS method further includes: notifying a control centre of the at least one network error or outage or flap event associated with the at least one birefringence event.

In some embodiments, step (c) in paragraph includes: dividing the backscattered optical signals into a first polarisation channel and a second polarisation channel, orthogonal to the first polarisation channel; dividing the optical reference signal into a third polarisation channel, parallel to the first polarisation channel, and a fourth polarisation channel, parallel to the second polarisation channel; combining the first polarisation channel of the backscattered optical signals and the third polarisation channel of the optical reference signals; and/or combining the second polarisation channel of the backscattered optical signals and the fourth polarisation channel of the optical reference signals.

In some embodiments, a centre frequency of the optical reference signal is different from a centre frequency of the backscattered optical signals.

In some embodiments, determining the at least one polarisation state change is based on determination of at least one of instantaneous magnitude and instantaneous phase change over time.

In some embodiments, the at least one birefringence event is caused by anisotropic stress on the at least one optical fibre. In some embodiments, the anisotropic stress on the at least one optical fibre is caused by physical handing of the at least one optical fibre including at least one of moving, pulling, bending, or twisting of the at least one optical fibre.

A distributed fibre optic sensing (DFOS) system is described, which includes: an optical signal transmitter arrangement configured to repeatedly transmit interrogating optical signals into at least one optical fibre; an optical signal receiver arrangement configured to: receive backscattered optical signals in a distributed manner along the at least one optical fibre; wherein the optical signal receiver arrangement includes: at least one optical combiner configured to combine the backscattered optical signals and an optical reference signal; and at least one photodetector configured to provide electrical signals based on the combined optical signals; and a processing system configured to: process the electrical signals to determine at least one polarisation state change of the backscattered optical signals along the at least one optical fibre; and determine at least one birefringence event based on the at least one polarisation state change.

In some embodiments, the DFOS system further includes a distributed acoustic sensing (DAS) capability, the processing system being further configured to process the backscattered optical signals in parallel to determine at least one acoustic and/or weight-induced strain disturbance in addition to the at least one birefringence event. In some embodiments, determining at least one acoustic disturbance is based on a spatial differentiation of phase difference between the backscattered optical signals and the optical reference signal across the optical fibre space domain.

In some embodiments, determining the at least one birefringence event is based on the at least one polarisation state change exceeding a predetermined threshold.

In some embodiments, the at least one optical fibre forms at least part of a fibre-optic communications network; and the processing system is further configured to determine at least one network error or outage or flap event in physical layer according to the at least one birefringence event, including determining location of the at least one network error or outage or flap event. In some embodiments, the processing system is further configured to notify a control centre of the at least one network error or outage or flap event associated with the at least one birefringence event.

In some embodiments, the DFOS system further includes: a first optical polariser configured to divide the backscattered optical signals into a first polarisation channel and a second polarisation channel, orthogonal to the first polarisation channel; and a second optical polariser configured to divide the optical reference signal into a third polarisation channel, parallel to the first polarisation channel, and a fourth polarisation channel, parallel to the second polarisation channel; wherein the at least one optical combiner includes at least one of: a first optical combiner configured to combine the first polarisation channel of the backscattered optical signals and the third polarisation channel of the optical reference signal; and a second optical combiner configured to combine the second polarisation channel of the backscattered optical signals and the fourth polarisation channel of the optical reference signals.

In some embodiments, a centre frequency of the optical reference signal is different from a centre frequency of the backscattered optical signals.

In some embodiments, determining the at least one polarisation state change is based on determination of at least one of instantaneous magnitude and instantaneous phase change over time.

In some embodiments, the at least one birefringence event is caused by anisotropic stress on the at least one optical fibre. In some embodiments, the anisotropic stress on the at least one optical fibre is caused by physical handling of the at least one optical fibre, including at least one of moving, pulling, bending, twisting of the at least one optical fibre.

A method is also described, which includes: (a) repeatedly transmitting interrogating optical signals into at least one optical fibre; (b) receiving backscattered optical signals in a distributed manner along the at least one optical fibre; (c) combining the backscattered optical signals and an optical reference signal; (d) processing the combined signals to determine at least one polarisation state change of the backscattered optical signals along the at least one optical fibre; (e) determining at least one birefringence event based on the at least one polarisation state change; (f) determining that the at least one birefringence event is caused by physical handling of the at least one optical fibre; (g) notifying a control centre of the at least one birefringence event and/or the physical handling of the at least one optical fibre associated with the at least one birefringence event.

In some embodiments, step (e) in paragraph includes determining location of the at least one birefringence event; and/or step (f) in paragraph includes determining location of the physical handling of the at least one optical fibre. In some embodiments, step (g) in paragraph further includes notifying the control centre of (1) the location of the at least one birefringence event and/or (2) the location of the physical handling of the at least one optical fibre associated with the at least one birefringence event.

In some embodiments, the method further includes: (h) determining at least one network error or outage or flap event in a physical layer according to the at least one birefringence event, including determining location and time of the at least one network error or outage or flap event. In some embodiments, the method further includes: (i) notifying the control centre of the at least one network error or outage or flap event in a physical layer as an alternative or an addition to: (1) the at least one birefringence event and/or (2) the physical handling of the at least one optical fibre. In some embodiments, the method further includes: (j) determining liability of the at least one network error or outage or flap event in the physical layer. In some embodiments, step (j) includes processing non-distributed-fibre-optic-sensing (non-DFOS) data. In some embodiments, processing the non-DFOS data including correlating the non-DFOS data with DFOS data derived from the backscattered optical signals based on time and/or location information.

In some embodiments, the non-DFOS data includes (1) visual information captured by one or more one or more visual media capturing devices/systems and/or (2) log data recorded by the control centre in relation to physical handling of the at least one optical fibre.

In some embodiments, the non-DFOS data indicates at least one event and/or who are responsible for the at least one network error or outage or flap event in the physical layer.

A method is also described, which includes: (a) determining at least one birefringence event occurring at a position along at least one optical fibre based on distributed fibre optic sensing (DFOS) data; (b) processing the DFOS data in conjunction with non-DFOS data; (c) determining one or more causes of at least one network error or outage or flap event associated with the at least one birefringence event based on results of step (b).

In some embodiments, step (b) in paragraph includes correlating the non-DFOS data with the DFOS data based on time and/or location information.

In some embodiments, the non-DFOS data includes (1) visual information captured by one or more one or more visual media capturing devices/systems and/or (2) log data recorded by a network operations centre in relation to physical handling of the at least one optical fibre.

In some embodiments, the non-DFOS data indicates an event and/or who are responsible for the at least one network error or outage or flap event in physical layer.

In some embodiments, the method further includes: (d) notifying a control centre of the at least one network error or outage or flap event and/or the one or more causes of the at least one network error or outage or flap event.

In some embodiments, the method further includes: (e) providing feedback information associated with iteratively improving one or more ways of handling the optical fibre to reduce exposure of a network to threats of the at least one network error or outage or flap.

Further embodiments will become apparent from the following description, given by way of example and with reference to the accompanying drawings.

### BRIEF DESCRIPTION OF THE DRAWINGS

FIG. 1 illustrates an exemplary arrangement of a DFOS system.

FIG. 2A illustrates exemplary returning optical signals of the DFOS system in FIG. 1 over optical distance.

FIG. 2B illustrates exemplary returning optical signals of the DFOS system in FIG. 1 in time domain.

FIG. 2C illustrates exemplary returning optical signals of the DFOS system in FIG. 1 in time-space domain.

FIG. 3 illustrates an exemplary arrangement of an optical signal transmitter and a first exemplary arrangement of an optical signal receiver of the DFOS system in FIG. 1.

FIG. 4 illustrates a second exemplary arrangement of an optical signal receiver of the DFOS system in FIG. 1.

FIG. 5 illustrates a first exemplary process performed by a processing system of a DFOS system.

FIG. 6 illustrates exemplary digital electrical signals of two orthogonal polarisation channels.

FIG. 7 illustrates a second exemplary process performed by a processing system of a DFOS system.

FIG. 8 illustrates an exemplary density plot of electrical signals generated by a DFOS system.

### DETAILED DESCRIPTION OF THE EMBODIMENTS

Reference to fibre optic sensing in this disclosure should be read as including any propagating wave or signal that imparts a detectable change in the optical properties of the sensing optical fibre. These propagating waves or signals detected in the DFOS system may include signal types including one or more of acoustic signals, seismic waves, vibrations, stress to the fibre core, and slowly varying and very low frequency (DC-type) signals such as weight-induced compression waves that induce for example localised strain changes in the optical fibre. The fundamental sensing mechanism in one of the preferred embodiments is a result of the stress-optic effect but there are other sensing mechanisms in the optical fibre that this disclosure may exploit such as the thermo-optic effect and magneto-optic effect.

Inventors of the present application have discovered that physical handling/movement of the optical fibre may be associated with polarisation information of the optical signals transmitted within the optical fiber. However, conventional DFOS methods and/or systems may not utilise polarisation information but rely for example on distributed acoustic sensing (DAS) relying on vibrations of the cable. Consequently physical handling/movement of the optical fibre that would generate minor vibrations may not be discriminated from other more dominant acoustic disturbances and/or vibration-induced background noise and may therefore not be detected with conventional DFOS methods and/or systems such as DAS. The present disclosure may provide DFOS methods and systems for detecting or isolating and locating such physical handling/movement of the optical fibre over and may therefore provide prompt diagnosis of or mitigate the subsequent network errors, network flap events and/or network outages. The present disclosure may also provide DFOS methods and systems that provide an improved signal-to-noise ratio of the backscattered signal based on distributed polarisation sensing (DPS).

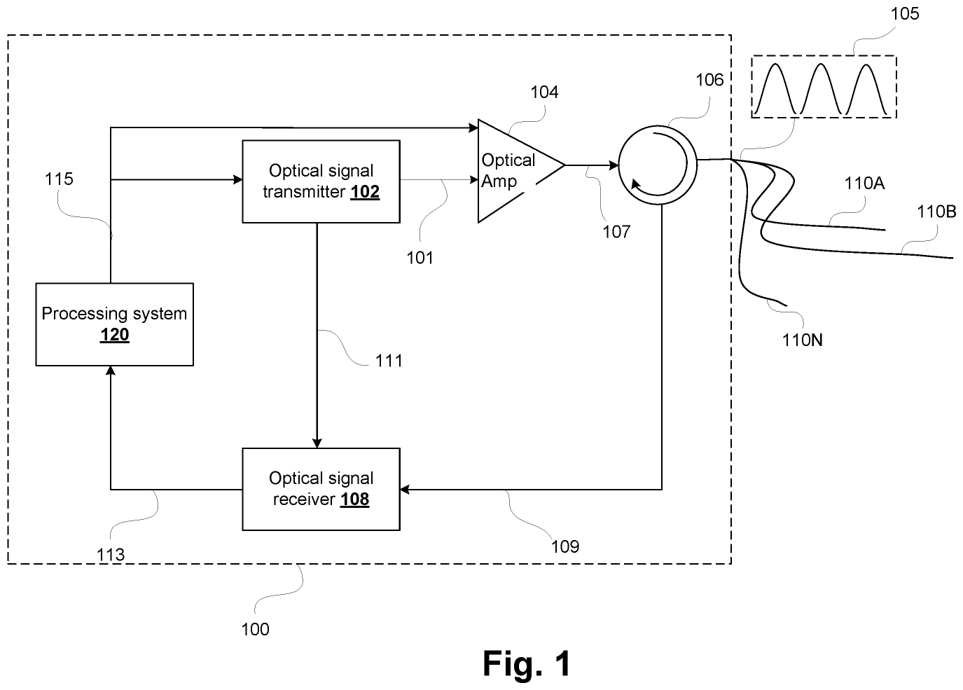

FIG. 1 illustrates an exemplary arrangement of a DFOS system 100. The blocks (in FIG. 1 or other system figures of the present disclosure) represent functional components of the DFOS system 100. It will be appreciated that functionality may be provided by distinct or integrated physical components. The DFOS system 100 includes an optical signal transmitter 102 to transmit optical signals 101, for example, in the form of repeatedly transmitted optical pulses, into at least one optical fibre 110A, 110B, . . . , 110N. The at least one optical fibre 110A, 110B, . . . , 110N may be distributed across a geographical area. In some embodiments, the at least one optical fibre may form part of established and dedicated fibre-optic communications network. Techniques for repurposing the optical fibre forming part of established and dedicated fibre-optic communications network are described in international patent application no. PCT/AU2017/050985 (published as WO 2018/045433), the entire content of which is incorporated herein by reference.

In some embodiments, the optical signals 101 are provided to at least one optical amplifier 104, resulting in an overall amplification of the optical signals, i.e. amplified optical signals 103, to extend the reach of interrogating signals. In one example, the at least one optical amplifier 104 includes an Erbium doped fibre amplifier (EDFA). The at least one optical amplifier 104 may be a single stage amplifier or a multi-stage optical amplifier. In some embodiments, an optical attenuator may be used (not shown) following the at least one optical amplifier 104 to adjust the power of the amplifier output. In some embodiments, the at least one optical amplifier 104 is omitted. The DFOS system 100 may also include an optical circulator 106 configured to direct the optical signals 101 or the amplified optical signals 103 to the at least one optical fibre (110A, 110B, . . . , 110N) as interrogating optical signals 105. In some examples, the interrogating optical signals 105 may include a series of pulses each with power of 0.1-10 mW (such as around but not limited to 0.1, 0.24, 2.8, 5.78, 8, 9.45 and 10 mW) and duration of 1-100 ns (such as around but not limited to 1.23, 4, 25.7, 40.68, 80, 92.3, 99.31 and 100 ns).

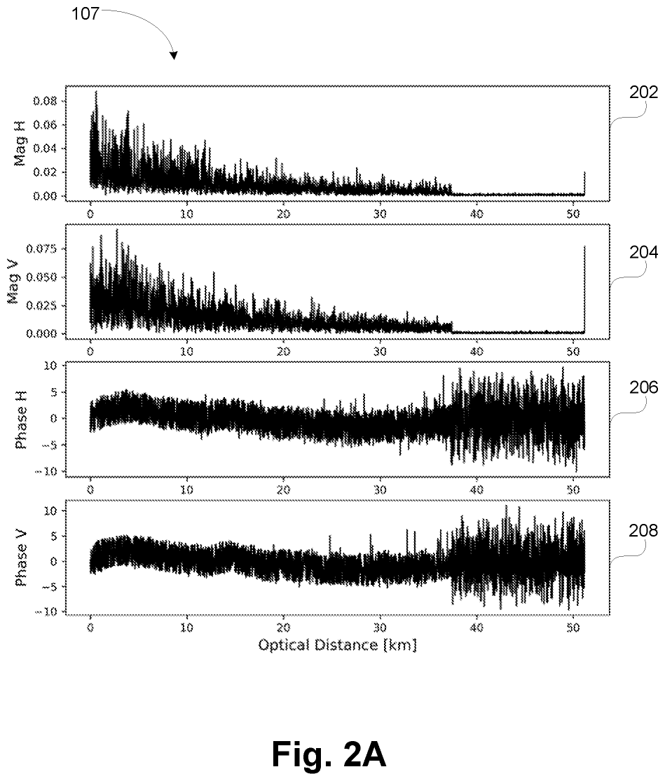

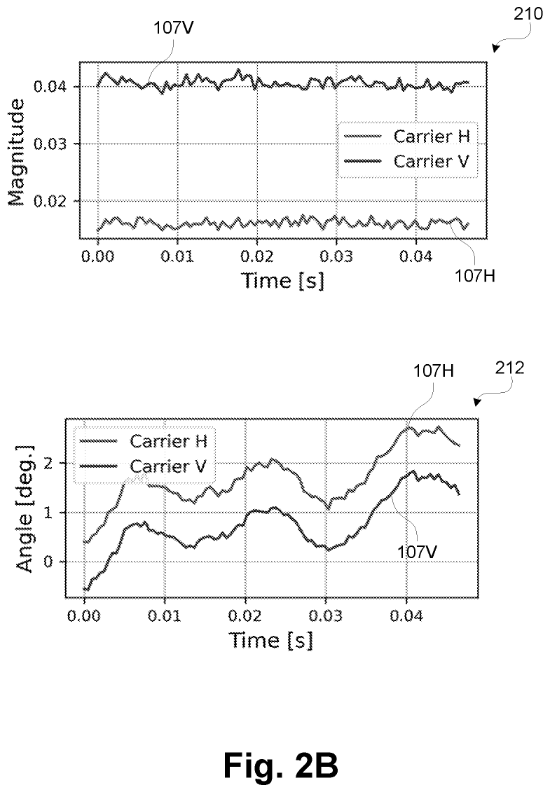

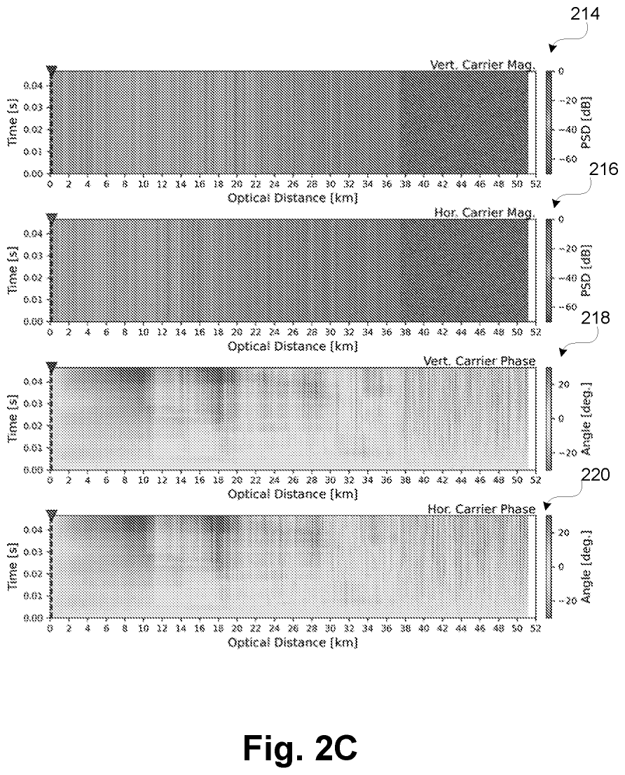

The optical circulator 106 also receives returning optical signals 107 backscattered along the at least one optical fibre (110A, 110B, . . . , 110N) and outputs backscattered optical signals 109 to an optical signal receiver 108. FIG. 2A illustrates exemplary returning optical signals 107 including two orthogonal polarisation channels (e.g. vertical polarisation channel 202, 206 and horizontal polarisation channel 204, 208) in space domain, i.e., over optical distance representing position along the optical fibre. In particular, plots 202 and 204 show magnitudes of the horizontal and vertical polarisation channels, respectively, and plots 206 and 208 show phases of the horizontal and vertical polarisation channels, respectively.

FIG. 2B illustrates exemplary returning optical signals 107 including two orthogonal polarisation channels (e.g. vertical polarisation channel 107V and horizontal polarisation channel 107H) in time domain (plots 210 and 212), i.e. over time. FIG. 2C illustrates exemplary returning optical signals 107 including to orthogonal polarisation channels (e.g. vertical polarisation channel 107V and horizontal polarisation channel 107H) in time-space domain (plots 214, 216, 218, and 220). In particular, the plot 210 shows exemplary magnitude of the vertical polarisation channel 107V and horizontal polarisation channel 107H of the returning optical signals 107. The plot 212 shows exemplary phase of the vertical polarisation channel 107V and horizontal polarisation channel 107H of the returning optical signals 107. The plots 214 and 216 are density plots illustrating magnitude of the vertical polarisation channel 107V and horizontal polarisation channel 107H, respectively, over time and optical distance. The plots 218 and 220 illustrate phase of the vertical polarisation channel 107V and horizontal polarisation channel 107H, respectively, over time and optical distance. In the examples of FIGS. 2A, 2B and 2C, the optical fibre terminates at around 37 km. The returning optical signals 107 may be backscattered in a distributed manner (e.g. via Rayleigh back scattering or other similar scattering phenomena) along the length of the at least one optical fibre (110A, 110B, . . . , 110N).

The backscattered optical signals 109 arriving at the optical signal receiver 108 as a function of time after fibre transmission have a time-dependence on the travelled optical fibre distance. The two-way (i.e. outgoing and returning) travel time of the backscattered optical signals 109 is used to multiplex the optical fibre into a series of linear channel positions spanning the entire optical fibre path. It will be appreciated that other devices other than optical circulators may be used to connecting the optical signal receiver 108 and the at least one optical fibre (110A, 110B, . . . , 110N), including but not limited to optical couplers and array waveguide gratings. The optical signal receiver 108 may also receive an optical reference signal 111 for detection of the backscattered optical signals 109. In some embodiments, the optical reference signal 111 is provided by the optical signal transmitter 102. The optical signal transmitter 102 and the optical signal receiver 108 (with or without the optical amplifier 104 and the optical circulator 106) may form a coherent optical time-domain reflectometer (C-OTDR).

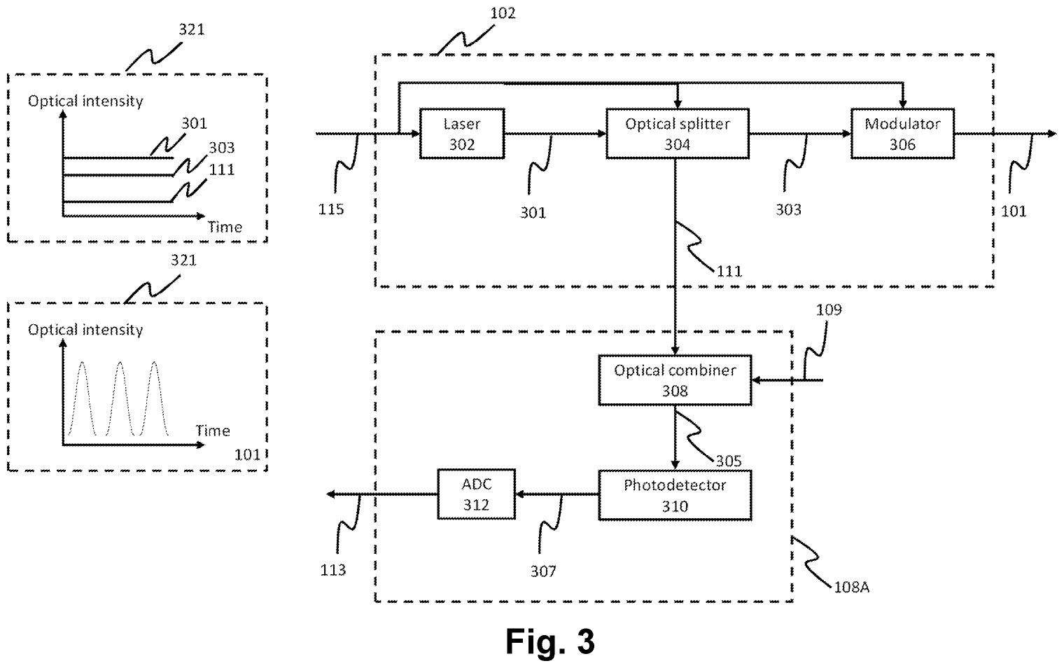

FIG. 3 illustrates an exemplary arrangement of an optical signal transmitter 102 and a first exemplary arrangement of an optical signal receiver 108A of the DFOS system in FIG. 1. In FIG. 3 like components and features to those described with reference to FIG. 1 are shown with like reference numerals.

In the example as shown in FIG. 3, the optical signal transmitter 102 includes at least one laser 302 to provide light 301. In some embodiments, the at least one laser 302 includes a narrowband continuous wave (CW) lased module that this typically in C- or L-band. The optical signal transmitter also includes an optical beam splitter to provide a first portion of the light 301 for DFOS (i.e. light 303) and a second portion of the light 301 as the optical reference signal 111 (e.g. an optical local oscillator signal). An inset 321 in FIG. 3 illustrates exemplary optical intensities over time of the light 301, 303 and the optical reference signal 111. In some embodiments, the optical reference signal 111 may be provided by a local oscillator light source that is independent from the at least one laser 302 (not shown). In one example, the local oscillator light source is operated at the same wavelength as the at least one laser 302 for homodyne detection. In another example, the local oscillator light source is operated at a different wavelength from the at least one laser 302 for heterodyne detection. The light 303 is provided to a modulator 306. The modulator 306 is configured to control the power, frequency, phase, shape, polarisation and/or spatial direction of the interrogating optical signals 101. An inset 322 in FIG. 3 illustrates an exemplary optical intensity plot over time of the interrogating optical signals 101. In the example of heterodyne detection (the optical reference signal may be provided by the at least one laser 302 or the independent local oscillator light source), the modulator 306 may be used to shift the frequency of the interrogating optical signals so that the centre frequency of the interrogating optical signals is different from the frequency of the optical reference signal to avoid DC noise at detection stage. Various types of modulators may be used, including but not limited to acousto-optic modulators and electro-optic modulators. The modulator 306 then outputs modulated optical signals (i.e. the optical signals 101) for amplification and/or interrogation.

FIG. 3 also illustrates the first exemplary arrangement of an optical signal receiver 108A that may be used in the DFOS system 100. In this example, the optical signal receiver 108A includes an optical combiner 308 configured to combine the backscattered optical signals 109 and the optical reference signal 111 and output combined optical signals 305. The optical signal receiver 108A also includes at least one photodetector 310 configured to receive the combined optical signals 305 and output electrical signals 307 that are representative of the combined optical signals 305. The electrical signals 307 may be in the form of electrical current proportional to a combined amplitude (or intensity) of two electric fields (i.e. E_{BS} and E_{LO}) of the backscattered optical signals 109 and the optical reference signal 111, respectively. The two electric fields can be expressed mathematically in the following forms, respectively:

$${E}_{L O} ( n , t ) = \frac{1}{2} {E}_{L {O}_{n}} {e}^{\pm i ( {Φ}_{L {O}_{n}} ( t ) - {ω}_{L O} ( t ) \cdot t )} , \qquad ( 1 )$$

$${E}_{B S} ( n , t ) = \frac{1}{2} {E}_{B {S}_{n}} {e}^{\pm i ( {Φ}_{B {S}_{n}} ( t ) - {ω}_{B S} ( t ) \cdot t )} , \qquad ( 2 )$$

where E_{LO}(n, t) is the electric field of the optical reference signal 111 for position n of the optical fibre (i.e. fibre optic channel n) at time t and E_{BS}(n, t) is the electric field of the backscattered optical signals 109 arriving from position n of the optical fibre (i.e. fibre optic channel n) at time t. E_{LO}_{ₙ} is the electric field amplitude of the optical reference signal 111 for fibre optic channel n and E_{BS}_{ₙ} is the electric field amplitude of the backscattered optical signals 109 arriving from fibre optic channel n. Φ_{LO}_{ₙ} (t) is a local phase (i.e. phase for fibre optic channel n) at time t for the optical reference signal 111 and Φ_{BS}_{ₙ} (t) is a local phase (i.e. phase for fibre optical channel n) at time t for the backscattered optical signals 109. ω_{LO}(t) is an instantaneous carrier frequency for the optical reference signal 111 and ω_{BS}(t) is an instantaneous carrier frequency for the backscattered optical signals 109.

The time-dependent superposition (combination) of the optical reference signal 111 and the backscattered optical signals 109 (i.e. the combined optical signals 305) at the at least one photodetector 310 yields the electrical signals 207 (i.e. a photocurrent (I)) in the following form:

$$I = \frac{1}{4} {\vert {E}_{L O} \vert}^{2} + \frac{1}{4} {\vert {E}_{B S} \vert}^{2} + \frac{1}{4} \vert {E}_{L O} \vert \vert {E}_{B S} \vert [ {e}^{\pm i ( ( Δ Φ ) - ( Δω ) t )} + {e}^{\pm i ( ( - Δ Φ ) - ( - Δ ω ) t )} ] , \qquad ( 3 )$$

where ΔΦ is a phase difference between optical reference signal 111 and the backscattered optical signals 109, indicating a change in the local phase, and Δω is a difference between the instantaneous carrier frequencies of the optical reference signal 111 and the backscattered optical signals 109, called carrier frequency of the electrical signals 307. As shown in Equation (3), the electrical signals 207 include four terms, the first two of which (i.e., ¼|E_{LO}|² and ¼|EBS|²) are DC components, and the last two of which occur at positive and negative carrier frequencies, respectively (so called positive and negative carrier frequency terms). The positive and negative carrier frequency signals are identical, therefore one of which may be processed for further analysis. Part of the electrical signals 307 (e.g. positive or carrier frequency signals) or the entire electrical signals 307 may be digitised by at least one analogue-to-digital converter (ADC) 312, which outputs digital electrical signals 113 to a processing system 120 for further processing and/or analysis. In some embodiments, the optical signal transmitter 102 and/or the optical amplifier are operatively controlled by the processing system 120 via control path(s) 115. For example, one or both of the laser 302 (e.g. its wavelength and/or output power) and the operation of the modulator 306 (e.g. the modulation waveform) of the optical signal transmitter 102 may be controlled by the processing system 120. In another example, the operation of the optical splitter 304 (e.g. the splitting ratio between the light 303 and the optical reference signal 111) is controlled by the processing system 120. In another example, the gain of the optical amplifier 104 is controlled by the processing system 120.

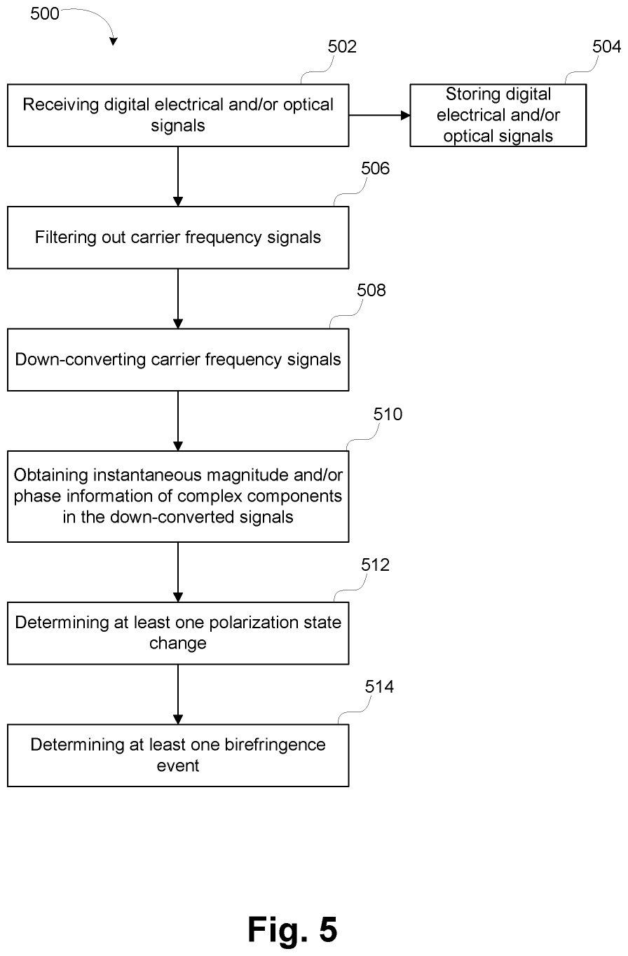

FIG. 5 illustrates a first exemplary process 500 performed by the processing system 120. At step 502, the processing system receives the digital electrical signals 113. In some embodiments, the digital electrical signals 113 are stored in a storage unit (not shown) at step 502. The storage unit may include volatile memory, such as random access memory (RAM) for the processing system 120 to execute instructions, calculate, compute or otherwise process data. Additionally or alternatively, the storage unit may include non-volatile memory, such as one or more hard disk drives for the processing system 120 to store data before or after signal processing and/or for later retrieval. The processing system 120 and storage unit may be distributed across numerous physical units and may include remote storage and potentially remote processing, such as cloud storage, and cloud computing. In addition or as an alternative to the digital electrical signals 113 being stored, the backscattered optical signals 109 may be digitised, received by the processing system 120 at step 502 and stored as raw optical data (i.e. data derived from the optical signals which has not been demodulated) at step 504.

In some embodiments, the carrier frequency signals (e.g. the positive carrier frequency signals in Equation 3) may be filtered out by a filter, such as a high-pass filter, at step 506. At step 508, the carrier frequency signals are then down-converted to baseband (i.e. from the carrier frequency to DC frequency). At step 510, instantaneous magnitude and/or phase information of complex components in the down-converted signals are obtained. For example, the down-converted signals may be passed to a rectangular-to-polar coordinate converter, wherein inputs are real and imaginary components and outputs are instantaneous magnitude and phase angle of a polar coordinate vector in the complex domain. Analysis of the instantaneous magnitude and/or instantaneous phase angle of the down-converted signals provides a time series of how the polarisation state changes along the optical fibre. At least one polarisation state change is determined at step 512, for example, based on the instantaneous magnitude and/or phase information. That is, each of the positive and negative carrier frequency signals include information about the magnitude and local phase of each fibre optic channel (i.e. position along the optical fibre path), which provides a basis for distributed polarisation sensing (DPS) and therefore detecting and locating at least one major polarisation state change. In some embodiments, the at least one major polarisation state change is defined as at least one polarisation state change exceeding a predefined threshold (e.g. 1 krad/s).

A person skilled in the field of telecommunications would appreciate that minor polarisation state change events (e.g. 1 rad/s-10 krad/s) may be unlikely to cause network outage because they are within the range of coherent transponder tracking (e.g. 1 rad/s-10 Mrad/s), however, these events are associated with physical handling/movement of the optical fibre, which may be associated with network errors, network flap events and/or network outages in the telecommunications network. The sensitivity of the disclosed DPS method to detecting physical handling/movement of the optical fibre and the association of physical handling/movement of the optical fibre with network errors, network flap events and/or network outages may therefore be an advantage of the disclosed DPS method.

In telecommunications, a network flap event or route flap event occurs when a data packet's destination or route changes rapidly, or becomes unavailable and then available again in a short time. Flap events are observed at the network level, but, as discussed above, may be ultimately caused by errors introduced along the optical fibres or devices within discrete portions of the network. For example, when a telecommunications system technician services a fibre optic cables, as occurs for example dozens of times per day in a city, the technician will often move loops of excess telecommunications cabling stored within a ground pit as they proceed to access a particular fibre junction. This physical activity may cause a change in the state of the environment of the at least one optical fibre, which may lead to network errors, network flap events and/or network outages. When an error occurs, for example across one optical fibre, the flow of packets through this piece of the network becomes distorted and neighbouring routers may recalculate the next route hop for this packet again. The longer it takes to recalculate a new path for the stalled packet, the more significant the risk of a network flap event, service latency, and potentially network outage.

The ultimate cause and location of a network error/outage/flap event is typically unknown at the time of failure. In some examples, the ultimate cause is a hardware error, a software error, a node-to-node interface error, a configuration error, an intermittent error caused by physical motion in at least one optical fibre, or unreliable connection(s) within the network. Any of these errors may cause certain router addressing and availability information to be repeatedly advertised and/or withdrawn. Depending on specific network topology and protocol (link-state routing, distance-vector routing, route aggregation, etc.), the associated risk of errors cascading into network flap events may be different. For example, a link-state routing protocol may be typically sensitive to network errors because of how each node independently calculates its routing table.

Some strategies are commonly deployed in telecommunications networking to reduce network flap events and therefore improve customer services. A first strategy is adjusting the networking technique, such as route dampening and route aggregation. This strategy may be implemented in a top-down fashion across the entire network. For example, route dampening penalises network route segments that have historically caused flaps in an automated manner by suppressing packet traffic through these segments for a predefined duration. A second strategy is layer one hardening, wherein network flaps are eliminated by physically inspecting and correct the misaligned or problematic devices, device connections, optical fibres, optical fibre joints and/or optical fibre slices. A third strategy is deploying a network monitoring service or network operation centre to register and respond to activity in real-time as the activity information becomes available.

In some embodiments, physical handling of the at least one optical fibre including moving, pulling, bending, and/or twisting of the at least one optical fibre may apply anisotropic stress to the optical fibre's core and generate refractive index anisotropy, so called birefringence. The polarisation state of the interrogating optical signals 105 undergoing this birefringence varies accordingly. The DFOS system 100 may therefore be used to detect and locate at least one major polarisation state change by analysing at least one of the carrier frequency signals in the digital electrical signals 113, which includes information about the magnitude and local phase of the backscattered optical signals 109 at each fibre optic channel (i.e. position along the optical fibre path). The processing system 120 may be configured to determine at least one birefringence event based on the at least one polarisation state change at step 514. In the embodiments where the at least one optical fibre forms at least part of a fibre-optic communications network, the processing system 120 is further configured to determine and locate at least one network error or outage or flap event according to the at least one birefringence event. As a result, the present disclosure may facilitate prompt diagnosis of or mitigate the subsequent network errors, network flap events and/or network outages, for example, by implementing at least one of the above strategies.

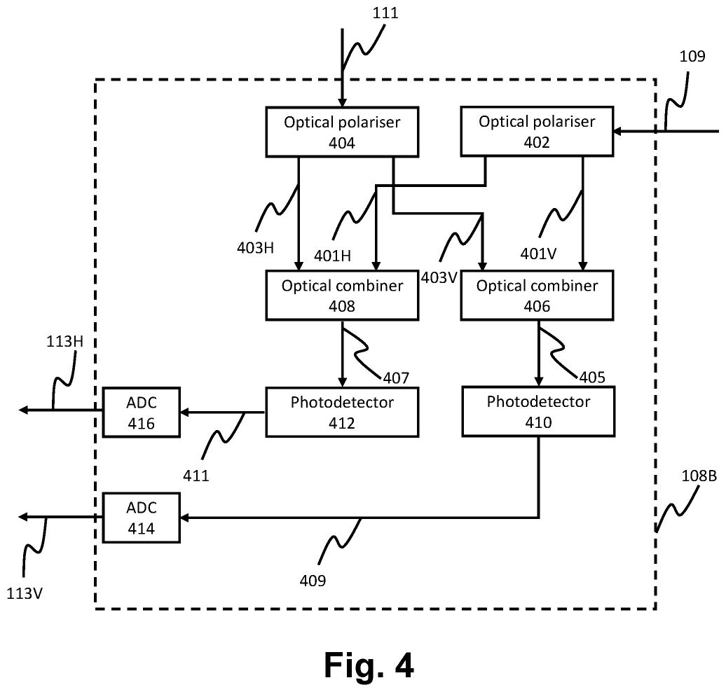

As the electric field amplitudes of the backscattered optical signals 109 and optical reference signals 111 are independent and random, there may be fibre optic channels (i.e. positions along the at least one optical fibre) for which the recorded intensity is zero due to destructive interference. This may lead to local phase information at the corresponding fibre position becoming non-recoverable. This is called optical fading. To eliminate this optical fading issue, the DFOS system 100 may employ a polarisation-diverse receiver 108B as for example illustrated in FIG. 4. The optical signal receiver 108B includes a first optical polariser 402 configured to divide the backscattered optical signals 109 into a first polarisation channel 401V (electric field of which is denoted by E_{BS}^{⊥}) and a second polarisation channel 401H (electric field of which is denoted by E_{BS}^{∥}). The polarisation state of the first polarisation channel 401V is orthogonal to and that of the second polarisation channel 401H. The optical signal receiver 108B also includes a second optical polariser 404 configured to divide the optical reference signal 111 into a third polarisation channel 403V (electric field of which is denoted by E_{LO}^{⊥}) and a fourth polarisation channel 403H (electric field of which is denoted by E_{LO}^{∥}). The polarisation state of the third polarisation channel 403V is parallel to that of the first polarisation channel 401V. The polarisation state of the fourth polarisation channel 403H is parallel to that of the second polarisation channel 401H. That is, the third polarisation channel 403V is orthogonal to the fourth polarisation channel 403H. The electric fields of the first to fourth polarisation channels (401V, 401H, 403V and 403H) are in the following mathematical forms, respectively:

$${E}_{B S}^{⊥} = {E}_{B S}^{⊥} {e}^{\pm i ( {Φ}_{B S}^{⊥} - {ω}_{B S} t )} , \qquad ( 4 )$$

$${E}_{B S}^{∥} = {E}_{B S}^{∥} {e}^{\pm i ( {Φ}_{B S}^{∥} - {ω}_{B S} t )} , \qquad ( 5 )$$

$${E}_{L O}^{⊥} = {E}_{L O}^{⊥} {e}^{\pm i ( {Φ}_{L O}^{⊥} - {ω}_{L O} t )} , \qquad ( 6 )$$

$${E}_{L O}^{∥} = {E}_{L O}^{∥} {e}^{\pm i ( {Φ}_{L O}^{∥} - {ω}_{L O} t )} , \qquad ( 7 )$$

The polarisation-diverse receiver 108B further includes at least one of a first optical combiner 406 and a second optical combiner 408. The first optical combiner 406 is configured to combine the first polarisation channel 401V of the backscattered optical signals 109 and the third polarisation channel 403V of the optical reference signal 111 and output first combined optical signals 405. The second optical combiner 308 is configured to combine the second polarisation channel 401H of the backscattered optical signals 109 and the fourth polarisation channel 403H of the optical reference signal 111 and output second combined optical signals 407. The combined optical signals 405 and 407 are provided to a first photodetector 410 and a second photodetector 412, respectively. The time-dependent superposition (combinations) of the polarisation channels of the optical reference signal 111 and the backscattered optical signals 109 with equal polarisation (i.e. the combined optical signals 405 and 407, respectively) at the respective first and second photodetector 410 and 412 yields the electrical signals 409 and 411 each in the form of a photocurrent (I^{⊥} and/I^{∥}, respectively) mathematically described below:

$${I}^{⊥} = \frac{1}{4} {\vert {E}_{L O}^{⊥} \vert}^{2} + \frac{1}{4} {\vert {E}_{B S}^{⊥} \vert}^{2} + \frac{1}{4} \vert {E}_{L O}^{⊥} \vert \vert {E}_{B S}^{⊥} \vert [ {e}^{\pm i ( ( Δ {Φ}^{⊥} ) - ( Δω ) t )} + {e}^{\pm i ( ( - Δ {Φ}^{⊥} ) - ( - Δω ) t )} ] , \qquad ( 8 )$$

$${I}^{∥} = \frac{1}{4} {\vert {E}_{L O}^{∥} \vert}^{2} + \frac{1}{4} {\vert {E}_{B S}^{∥} \vert}^{2} + \frac{1}{4} \vert {E}_{L O}^{∥} \vert \vert {E}_{B S}^{∥} \vert [ {e}^{\pm i ( ( Δ {Φ}^{∥} ) - ( Δω ) t )} + {e}^{\pm i ( ( - Δ {Φ}^{∥} ) - ( - Δ ω ) t )} ] , \qquad ( 9 )$$

Part of the electrical signals 409 and/or 411 (e.g. positive or negative carrier frequency signals) or the entire electrical signals 409 and/or 411 may be digitised by a first ADC 414 and/or a second ADC 416, respectively, which outputs digital orthogonal polarisation signals 113V and 113H, respectively, to the processing system 120 (at step 502) for further processing and/or analysis. In some embodiments, the digital orthogonal polarisation signals 113V and/or 113H are stored in the storage unit (not shown) at step 504. In addition or as an alternative to the digital orthogonal polarisation signals 113V and/or 113H being stored, the backscattered optical signals 109 and/or at least one of the first and second polarisation channels 401V and 401H may be digitised, received at step 502 and stored as raw optical data (i.e. data derived from the topical signals which has not been demodulated) at step 504.

As the positive and negative carrier frequency signals in Equation 8 or 9 are identical, therefore only positive carrier frequency signals may be processed for further analysis. In some embodiments, the positive carrier frequency signals in Equations 8 and/or Equation 9 may be filtered out by a filter, such as a high-pass filter, at step 506. The positive carrier frequency signals are then down-converted to baseband (i.e. from the carrier frequency to DC frequency) at step 508. This step may be achieved through multiplication by in-phase and quadrature components. At step 510, instantaneous magnitude and/or phase information of complex components in the down-converted signals are obtained. For example, the down-converted signals may be passed to the rectangular-to-polar coordinate converter, wherein inputs are real and imaginary components and outputs are instantaneous magnitude and phase angles of a polar coordinate vector in the complex domain. It will be understood that the instantaneous phase angle is cumulative over time but the trend can be determined based on differentiation over time. In some embodiments, time averaging of the complex components in the received electrical signals (before or after digitisation) may also be employed to improve the signal-to-noise ratio of the received electrical signals.

Analysis of the instantaneous magnitude and/or instantaneous phase angle of the down-converted signals that are representative of at least one of the orthogonal optical channels (i.e. 401V and 401H) provides a time series of how the polarisation state changes along the optical fibre. At least one polarisation state change is determined at step 512, for example, based on the instantaneous magnitude and/or phase information. The detected polarisation state change at any position within the DFOS system is a cumulative effect of the polarisation state change encountered along the outgoing and back-propagating paths. At step 514, the processing system 120 is further configured to determine at least one birefringence event based on the at least one polarisation state change. In the embodiments where the at least one optical fibre forms at least part of a fibre-optic communications network, the processing system 120 is further configured to determine and locate at least one network error or outage or flap event according to the at least one birefringence event.

As discussed above, the at least one birefringence event may be caused by anisotropic stress on the at least one optical fibre, which may be caused by physical handling of the at least one optical fibre including at least one of moving, pulling, bending, or twisting of the at least one optical fibre. The polarisation state of the interrogating optical signals 105 at a fibre position undergoing a birefringence event is random but assumed vary linearly as it travels along the optical fibre, such that at least one of the returning orthogonal polarisation channels are piecewise smooth in time and space. At any one fibre position, small magnitude and/or phase angles changes in at least one of the orthogonal polarisation channels are consistent with the piecewise smooth behaviour, but substantial magnitude and/or phase angle changes indicate major step changes in the polarisation state (referred to as forward coupling events). The detection and location of the at least one polarisation change form a basis for detecting and locating physical handling/movement of the optical fibre, and therefore alerting or providing risk assessment of potential network error/outage/flap events associated with the physical handling/movement of the optical fibre. In some embodiments, the at least one major polarisation state change is defined as at least one polarisation state change exceeding a predefined threshold (e.g. 1 krad/s).

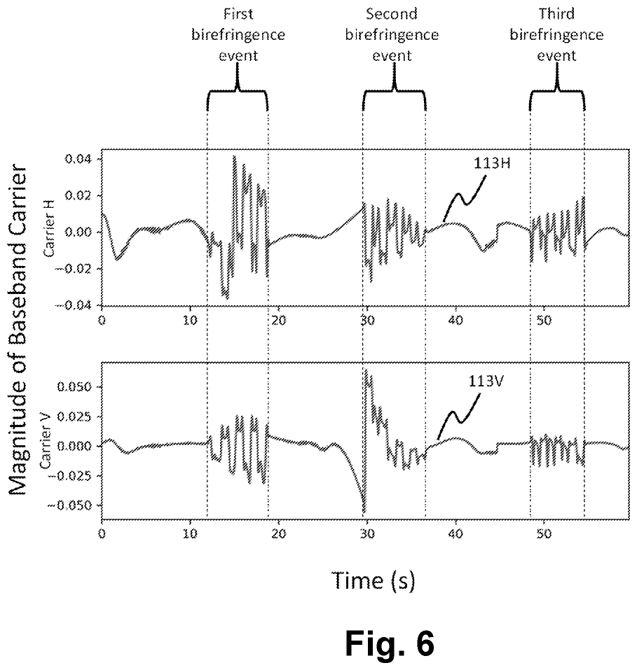

FIG. 6 illustrates exemplary digital electrical signals of two different polarisation channels (e.g. 113V and 113H) obtained from a field trial. In particular, FIG. 6 shows magnitude of baseband signals of two different polarisation channels in terms of time. In this example, a first birefringence event occurred from 12-19 seconds, a second birefringence event occurred from 29-36 seconds, and a third birefringence event occurred from 48-54 seconds. The time dependence on the travelled optical fibre distance can be then used to locate the first and/or second and/or third birefringence events so as to detect and locate potential network error/outage/flap events. It also can been seen that the two different polarisation signals are amplified by different amounts by the first, second and third birefringence events due to speeding up of one polarisation state while slowing down of the other polarisation state. A result of the birefringence event may be decoupling the magnitudes of the two polarisation signals by a random amount and thus a total phase shift for fibre positions beyond the position of the birefringent event.

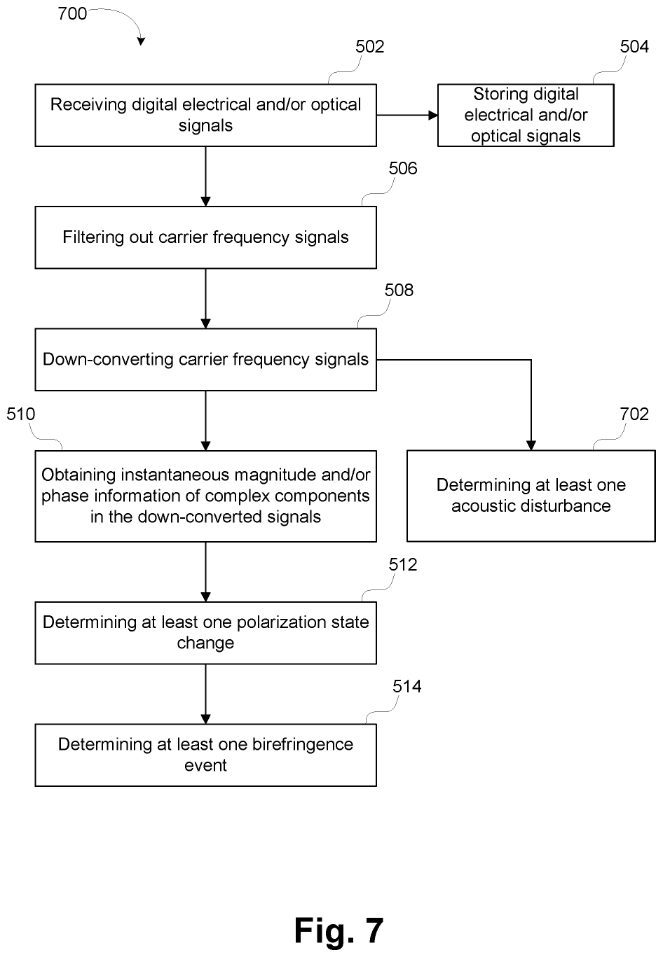

In some embodiments, the DFOS methods and systems with DPS capabilities described above may also be integrated with distributed acoustic sensing (DAS) capabilities. FIG. 7 illustrates a second exemplary process 700 performed by the processing system 120. In FIG. 7 like steps and features to those described with reference to FIG. 5 are shown with like reference numerals. In the process 700, the processing system 120 is configured in parallel to determine at least one acoustic disturbance caused by at least one object and/or event at step 702. As the down-converted signals are already in a form that includes acoustic information and permits acoustic analytics, additional lower level processing involving hardware/FPGA may be avoided. Combining capabilities of both DPS and DAS, which record complementary information, may also avoid the need to deploy a second system and/or second optical fibre. Techniques for determining the at least one acoustic disturbance including examples of the at least one acoustic disturbance are described in international patent application no. PCT/AU2019/051249 (published as WO 2020/097682), the entire content of which is incorporated herein by reference.

In other examples, spatial differentiation of the backscattered optical signals across the optical fibre space domain is used for DAS processing. The spatial differentiation of the phase in the first polarisation state is denoted as ΔΦ^{⊥}(n, t). The spatial differentiation of the phase in the second polarisation state, orthogonal to the first polarisation state, is denoted as ΔΦ^{∥}(n, t). ΔΦ^{⊥}(n, t) and ΔΦ^{∥}(n, t) can be mathematically described as:

$$Δ {Φ}^{⊥} ( n , t ) = \frac{Δ {Φ}_{n}^{⊥} - Δ {Φ}_{n + 1}^{⊥}}{dz} , \qquad ( 10 )$$

$${ΔΦ}^{∥} ( n , t ) = \frac{Δ {Φ}_{n}^{∥} - Δ {Φ}_{n + 1}^{∥}}{dz} , \qquad ( 11 )$$

That is, the step of spatial differentiation acts to subdivide the received optical signals by a length increment predetermined for the spatial differentiation (i.e. dz). This length is called gauge length, which may be any length but typically is on the order of a few meters. In some embodiments for DAS processing, the spatial differentiation of two orthogonal polarisation signals may be combined in complex domain to yield a total phase measurement (ΔΦ(n, t)):

$$Δ Φ ( n , t ) = Δ {Φ}^{⊥} ( n , t ) + Δ {Φ}^{∥} ( n , t ) , \qquad ( 12 )$$

In some embodiments, further processing steps include (a) taking a phasor average over some space or time and/or (b) measuring a deviation from the phasor average.

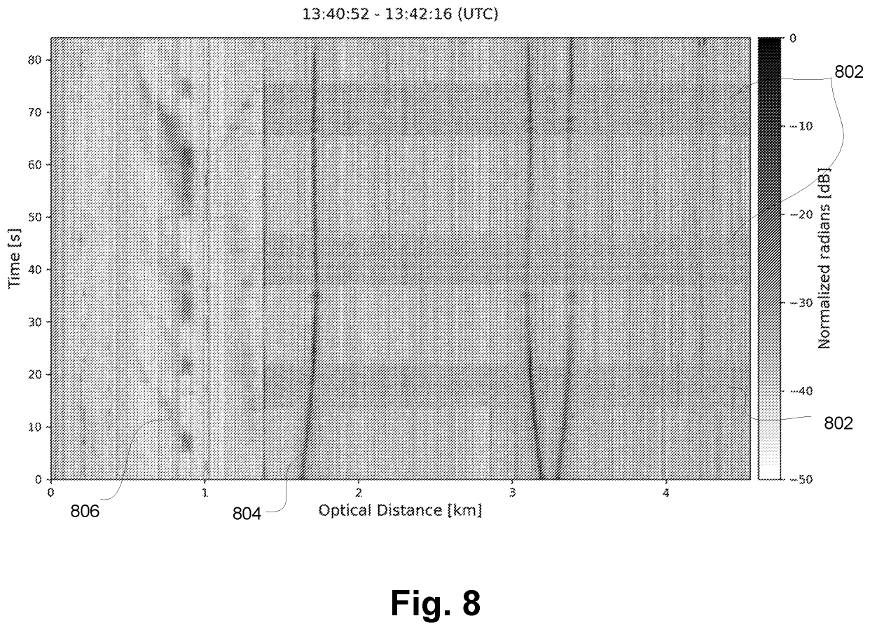

FIG. 8 illustrates an exemplary density plot 800 of electrical signals generated by a DFOS system from a field trial. Detection in the field trial is recorded over a full buried optical fibre at a 3.2 m spacing. The horizontal axis (labelled “Optical Distance [km]”) represents position along the optical fibre, the vertical axis (labelled “Time [s]”) represents time, and the grey scaled amplitude of the plot represents backscattered intensity. In this example, birefringence event testing involved 5-seconds of simulated birefringence variation separated by approximately 10 seconds of quiescence repeated three times. The associated signals (i.e. as shown by traces 702) extend from the location of the birefringence test at around 1.4 km to the end of optical fibre at 4.5 km due to the forward-coupling caused by combining the two orthogonal polarisation signals. In FIG. 8, features such as traces of straight lines with relatively constant gradients (e.g. 806) are associated with objects moving at a relatively constant speed (with the gradients being indicative of speed) that cause the relevant acoustic disturbances and events detected by the DFOS system 100. FIG. 8 also shows a trace 804 indicating a heavy object (e.g. a truck) slowly moving in the first few seconds and then stopping that cause the weight-induced strain detected by the DFOS system 100. Techniques for detecting weight-induced strain data are discussed in the incorporated international patent application no. PCT/AU2019/051249 (published as WO 2020/097682).

It can be seen from FIG. 8 and/or will be understood that the disclosed methods and/or systems are capable of detecting one or more birefringence events that would generate minor vibrations, acoustic disturbances and/or weight-induced strain activities. In particular, the disclosed methods and/or systems may facilitate better discrimination of the one or more birefringence events from the background which may include acoustic disturbances, weight-induced strain activities and/or other detected signals. These events which would be less readily distinguishable over such background when sensed using DAS techniques. This may be particularly desired for applications in dense/busy areas like urban areas.

Accordingly, the disclosed DFOS methods and systems may provide real-time updates about state of threats across the entire telecommunication network. In some embodiments, the disclosed DFOS methods and systems are used to determine at least one birefringence event and determine that the at least one birefringence event is caused by physical handling of at least one optical fibre. Then, a control centre may be notified with the at least one birefringence event and/or the physical handling of the at least one optical fibre associated with the at least one birefringence event. Location and/or time of the at least one birefringence event and/or the physical handling of the at least one optical fibre associated with the at least one birefringence event may also be notified to the control centre. In some embodiments, the disclosed DFOS methods and systems are used to determine at least one network error or outage or flap event in physical layer according to the at least one birefringence event, including determining location of the at least one network error or outage or flap event. In this regard, the at least one network error or outage or flap event and its location may be then notified to the control centre.

This may enable rapid determination of physical handling/movement of the optical fibre and therefore determine the root cause of a network error/outage/flap occurring in the physical layer rather than a higher layer, typically within a few meters (i.e. determining the position of network error/outage/flap at which pit in the field and/or which cabinet of the data centre). This may also enable culpability hand-off, such that outage/error/flap occurrence is causally linked in space and time to the agent causing it. Culpability hand-off may provide a benefit of being able to interdict on agents causing flaps, before they escalate to outages. It may also provide a benefit of hardening physical layer (i.e. Layer 1) over time, as the agent(s)/technician(s) may learn that their activities are being directly monitored and/or may improve their way(s) of more carefully handling the optical fibre(s) such as during pit visit(s) through feedback of the information provided from the disclosed DFOS methods and/or systems. In other words, the disclosed DFOS methods and systems may be used to iteratively improve and harden the exposure of the physical network to threats of network error/outage/flap. Combining capabilities of both DPS and DAS, which record complementary information, may avoid the need to deploy a second system and/or second optical fibre.

In some embodiments, a DFOS method and system may be used in conjunction with one or more non-DFOS methods and systems to detect, locate and/or notify cause(s) of one or more network errors/outages/flaps. That is, DFOS data may be used in conjunction with other non-DFOS data to detect, locate, determine and/or notify cause(s) of one or more network errors/outages/flaps.

The one or more non-DFOS systems include those employing artificial visual means, which collect visual information for applying techniques such as machine vision to detect and identify motion and associated events. For example, closed-circuit television (CCTV) cameras may be used for monitoring purposes. Each CCTV camera can provide one localised view of a streetmap at any one time with a depth of field of view determined by the optics of the CCTV camera. As another example, millimetre wave radar systems may be used to image the dynamic objects (e.g. one or more technicians) in an area with relatively high movement precision. As yet another example, satellite imagery may provide a city-wide bird's eye view of objects that are in the satellite's unobstructed line-of-sight. As yet another example, one or more light detection and ranging (LiDAR) systems looking down on one or more city areas may be used. The captured visual information as non-DFOS data may then be processed and analysed in conjunction with the DFOS data by, for example, correlating with the DFOS data based on time and/or location information, to determine one or more network errors/outages/flaps. For example, the disclosed DFOS system identifies a birefringence event occurring at a particular position along an optical fibre. The DFOS system employing DAS capabilities may also identify events associated with the detected birefringence event. The visual information captured by one or more visual media capturing devices/systems (e.g. a CCTV camera) monitoring that particular position and/or time may be analysed and indicates at least one event and/or who were associated with the detected birefringence event.

Additionally or alternatively, the one or more non-DFOS systems include those employing a network operations centre (NOC), which may record log data including pit visits and/or activities. For example, the disclosed DFOS system identifies a birefringence event occurring at a particular position along an optical fibre and at a particular time. The DFOS system employing DAS capabilities may also identify events associated with the detected birefringence event. The recorded information by the NOC such as pit visits and/or activities in relation to that optical fibre may be timestamped and analysed and indicates at least one event and/or who were associated with the detected birefringence event by correlating with the DFOS data based on time and/or location information.

As discussed above, these may enable determining root cause(s) of one or more network errors/outages/flaps and therefore establishing liability, i.e. identifying who are responsible for the one or more network errors/outages/flaps.

It will be understood that the invention disclosed and defined in this specification extends to all alternative combinations of two or more of the individual features mentioned or evident from the text or drawings. All of these different combinations constitute various alternative aspects of the invention.

1. A distributed fibre optic sensing (DFOS) method, the method including:
(a) repeatedly transmitting interrogating optical signals into at least one optical fibre;
(b) receiving backscattered optical signals in a distributed manner along the at least one optical fibre;
(c) combining the backscattered optical signals and an optical reference signal;
(d) processing the combined signals to determine at least one polarisation state change of the backscattered optical signals along the at least one optical fibre;
(e) determining at least one birefringence event based on the at least one polarisation state change.

2. The DFOS method of claim 1, further including distributed acoustic sensing (DAS) and processing the backscattered optical signals in parallel to determine at least one acoustic and/or weight-induced strain disturbance in addition to the at least one birefringence event.

3. The DFOS method of claim 2, wherein determining the at least one acoustic disturbance is based on a spatial differentiation of phase difference between the backscattered optical signals and the optical reference signal.

4. The DFOS method of any one of the preceding claims, wherein determining the at least one birefringence event is based on the at least one polarisation state change exceeding a predetermined threshold.

5. The DFOS method of any one of the preceding claims, wherein:
the at least one optical fibre forms at least part of a fibre-optic communications network; and
step (e) includes determining at least one network error or outage or flap event in physical layer according to the at least one birefringence event, including determining location of the at least one network error or outage or flap event.

6. The DFOS method of claim 5, further including:
notifying a control centre of the at least one network error or outage or flap event associated with the at least one birefringence event.

7. The DFOS method of any one of the preceding claims, wherein step (c) includes:
dividing the backscattered optical signals into a first polarisation channel and a second polarisation channel, orthogonal to the first polarisation channel;
dividing the optical reference signal into a third polarisation channel, parallel to the first polarisation channel, and a fourth polarisation channel, parallel to the second polarisation channel;
combining the first polarisation channel of the backscattered optical signals and the third polarisation channel of the optical reference signals; and/or
combining the second polarisation channel of the backscattered optical signals and the fourth polarisation channel of the optical reference signals.

8. The DFOS method of any one of the preceding claims, wherein a centre frequency of the optical reference signal is different from a centre frequency of the backscattered optical signals.

9. The DFOS method of any one of the preceding claims, wherein determining the at least one polarisation state change is based on determination of at least one of instantaneous magnitude and instantaneous phase change over time.

10. The DFOS method of any one of the preceding claims, wherein the at least one birefringence event is caused by anisotropic stress on the at least one optical fibre.

11. The DFOS method of claim 10, wherein the anisotropic stress on the at least one optical fibre is caused by physical handing of the at least one optical fibre including at least one of moving, pulling, bending, or twisting of the at least one optical fibre.

12. A distributed fibre optic sensing (DFOS) system, the system including:
an optical signal transmitter arrangement configured to repeatedly transmit interrogating optical signals into at least one optical fibre;
an optical signal receiver arrangement configured to:
receive backscattered optical signals in a distributed manner along the at least one optical fibre;
wherein the optical signal receiver arrangement includes:
at least one optical combiner configured to combine the backscattered optical signals and an optical reference signal; and
at least one photodetector configured to provide electrical signals based on the combined optical signals; and
a processing system configured to:
process the electrical signals to determine at least one polarisation state change of the backscattered optical signals along the at least one optical fibre; and
determine at least one birefringence event based on the at least one polarisation state change.

13. The DFOS system of claim 12 further including a distributed acoustic sensing (DAS) capability, the processing system being further configured to process the backscattered optical signals in parallel to determine at least one acoustic and/or weight-induced strain disturbance in addition to the at least one birefringence event.

14. The DFOS system of claim 13, wherein determining at least one acoustic disturbance is based on a spatial differentiation of phase difference between the backscattered optical signals and the optical reference signal across the optical fibre space domain.

15. The DFOS system of any one of claims 12 to 14, wherein determining the at least one birefringence event is based on the at least one polarisation state change exceeding a predetermined threshold.

16. The DFOS system of any one of claims 12 to 15, wherein:
the at least one optical fibre forms at least part of a fibre-optic communications network; and
the processing system is further configured to determine at least one network error or outage or flap event in physical layer according to the at least one birefringence event, including determining location of the at least one network error or outage or flap event.

17. The DFOS system of claim 16, wherein:
the processing system is further configured to notify a control centre of the at least one network error or outage or flap event associated with the at least one birefringence event.

18. The DFOS system of any one of claims 12 to 17, further including:
a first optical polariser configured to divide the backscattered optical signals into a first polarisation channel and a second polarisation channel, orthogonal to the first polarisation channel; and
a second optical polariser configured to divide the optical reference signal into a third polarisation channel, parallel to the first polarisation channel, and a fourth polarisation channel, parallel to the second polarisation channel; wherein
the at least one optical combiner includes at least one of:
a first optical combiner configured to combine the first polarisation channel of the backscattered optical signals and the third polarisation channel of the optical reference signal; and
a second optical combiner configured to combine the second polarisation channel of the backscattered optical signals and the fourth polarisation channel of the optical reference signals.

19. The DFOS system of any one of claims 12 to 18, wherein a centre frequency of the optical reference signal is different from a centre frequency of the backscattered optical signals.

20. The DFOS system of any one of claims 12 to 19, wherein determining the at least one polarisation state change is based on determination of at least one of instantaneous magnitude and instantaneous phase change over time.

21. The DFOS system of any one of claims 12 to 20, wherein the at least one birefringence event is caused by anisotropic stress on the at least one optical fibre.

22. The DFOS system of claim 21, wherein the anisotropic stress on the at least one optical fibre is caused by physical handling of the at least one optical fibre, including at least one of moving, pulling, bending, twisting of the at least one optical fibre.

23. A method, including:
(a) repeatedly transmitting interrogating optical signals into at least one optical fibre;
(b) receiving backscattered optical signals in a distributed manner along the at least one optical fibre;
(c) combining the backscattered optical signals and an optical reference signal;
(d) processing the combined signals to determine at least one polarisation state change of the backscattered optical signals along the at least one optical fibre;
(e) determining at least one birefringence event based on the at least one polarisation state change;
(f) determining that the at least one birefringence event is caused by physical handling of the at least one optical fibre;
(g) notifying a control centre of the at least one birefringence event and/or the physical handling of the at least one optical fibre associated with the at least one birefringence event.

24. The method of claim 23, wherein:
step (e) includes determining location of the at least one birefringence event; and/or
step (f) includes determining location of the physical handling of the at least one optical fibre.

25. The method of claim 24, wherein:
step (g) further includes notifying the control centre of (1) the location of the at least one birefringence event and/or (2) the location of the physical handling of the at least one optical fibre associated with the at least one birefringence event.

26. The method of any one of claims 23 to 25, further including:
(h) determining at least one network error or outage or flap event in a physical layer according to the at least one birefringence event, including determining location and time of the at least one network error or outage or flap event.

27. The method of claim 26, further including:
(i) notifying the control centre of the at least one network error or outage or flap event in a physical layer as an alternative or an addition to: (1) the at least one birefringence event and/or (2) the physical handling of the at least one optical fibre.

28. The method of claim 26 or claim 27, further including:
(j) determining liability of the at least one network error or outage or flap event in the physical layer.

29. The method of claim 28, wherein:
step (j) includes processing non-distributed-fibre-optic-sensing (non-DFOS) data.

30. The method of claim 29, wherein:
processing the non-DFOS data including correlating the non-DFOS data with DFOS data derived from the backscattered optical signals based on time and/or location information.

31. The method of claim 29 or claim 30, wherein:
the non-DFOS data includes (1) visual information captured by one or more one or more visual media capturing devices/systems and/or (2) log data recorded by the control centre in relation to physical handling of the at least one optical fibre.

32. The method of any one of claims 29 to 31, wherein the non-DFOS data indicates at least one event and/or who are responsible for the at least one network error or outage or flap event in the physical layer.

33. A method, including:
(a) determining at least one birefringence event occurring at a position along at least one optical fibre based on distributed fibre optic sensing (DFOS) data;
(b) processing the DFOS data in conjunction with non-DFOS data;
(c) determining one or more causes of at least one network error or outage or flap event associated with the at least one birefringence event based on results of step (b).

34. The method of claim 33, wherein:
step (b) includes correlating the non-DFOS data with the DFOS data based on time and/or location information.

35. The method of claim 33 or claim 34, wherein:
the non-DFOS data includes (1) visual information captured by one or more one or more visual media capturing devices/systems and/or (2) log data recorded by a network operations centre in relation to physical handling of the at least one optical fibre.

36. The method of any one of claims 33 to 35, wherein the non-DFOS data indicates an event and/or who are responsible for the at least one network error or outage or flap event in physical layer.

37. The method of any one of claims 33 to 36, further including:
(d) notifying a control centre of the at least one network error or outage or flap event and/or the one or more causes of the at least one network error or outage or flap event.

38. The method of any one of claims 33 to 37, further including:
(e) providing feedback information associated with iteratively improving one or more ways of handling the optical fibre to reduce exposure of a network to threats of the at least one network error or outage or flap.
